(19) United States
(12) Patent Application Publication
(10) Pub. No.: US 2016/0377917 A1
(43) Pub. Date: Dec. 29, 2016

(54) LIQUID CRYSTAL PANEL AND THE MANUFACTURING METHOD THEREOF

(71) Applicant: Yuejun Tang, Shenzhen Guangdong (CN)

(72) Inventor: Yuejun Tang, Shenzhen Guangdong (CN)

(21) Appl. No.: 14/902,418

(22) PCT Filed: Dec. 30, 2015
(86) PCT No.: PCT/CN2015/099740

§ 371 Date: Dec. 31, 2015

(30) Foreign Application Priority Data
Jun. 12, 2014 (JP) 2014-121290

(51) Int. Cl. G02F 1/1335

(52) U.S. Cl. CPC G02F 1/133555

(57) ABSTRACT

A display panel and the manufacturing method thereof are disclosed. The display panel includes a top substrate, a down substrate, a photoresist layer between the top substrate and the down substrate. The display panel includes a transmission area and a reflective area having a reflective layer within the photoresist layer. The reflective layer divides the photoresist layer into a first sub-photoresist layer and a second sub-photoresist layer. The first sub-photoresist layer is arranged between the reflective layer and the down substrate. The second sub-photoresist layer is arranged between the reflective layer and the top substrate. The light beams within the transmission area pass through the photoresist layer, the light beams within the reflective area pass through the first sub-photoresist layer or the second sub-photoresist layer twice. In this way, the saturation of the transmission area and the reflective area are compatible.

### BACKGROUND OF THE INVENTION

1. Field of the Invention

The present disclosure relates to liquid crystal display technology, and more particularly to a display panel and the manufacturing method thereof.

2. Discussion of the Related Art

LCDs are the most popular displays. The LCDs may include transflective LCDs and reflective LCDs in view of the adopted light sources. The light source of the transflective LCD is backlight. Only 5% of light beams are utilized after the light beams passing through polarizers and the liquid crystal panel. The power consumption of the backlight may be increased in order to enhance the brightness of the transflective LCDs. When the optical density of the ambient lights is greater than the light beams emitted from the LCD, it is possible that human eyes are not capable of viewing the contents displayed on the LCD. The reflective LCDs perform display by the ambient lights, and thus can only operate during day time or when the ambient light is enough, that is, the reflective LCDs cannot operate during night time or when the ambient light is weak. Thus, the transflective LCDs have been developed. The transflective LCDs adopt the backlight and the ambient lights as the light source in accordance with the environment.

With respect to the conventional transflective LCD, the light beams emitted from the transmission area of the backlight source pass through the photoresist layer once. Within the reflective area, the ambient lights may pass the photoresist layer twice during the incident and the reflective process. As such, the saturation of the reflective area may be too high and the light transmission rate of the reflective area may be lowered down. The saturation of the transmission area is not compatible with that of the reflective area. That is, the saturations of the transmission area and reflective area cannot meet product specification and demand.

### SUMMARY

The object of the invention is to provide a display panel and the manufacturing method thereof to overcome the incompatible saturations of the light beams within the transmission area and the reflective area regarding the transflective liquid crystal panel.

In one aspect, a display panel includes: a top substrate, a down substrate, a photoresist layer between the top substrate and the down substrate; the display panel includes a transmission area and a reflective area having a reflective layer within the photoresist layer, the reflective layer divides the photoresist layer into a first sub-photoresist layer and a second sub-photoresist layer, the first sub-photoresist layer is arranged between the reflective layer and the down substrate, the second sub-photoresist layer is arranged between the reflective layer and the top substrate, the light beams within the transmission area pass through the photoresist layer, the light beams within the reflective area pass through the first sub-photoresist layer or the second sub-photoresist layer twice; the display panel is a single-side display panel, the display panel further includes a light source arranged on the down substrate facing away the top substrate, the photoresist layer is arranged on the down substrate, and a reflective surface of the reflective layer faces toward the top substrate; and the reflective layer is a metallic reflective layer.

Wherein the first sub-photoresist layer and the second sub-photoresist layer are made by the same material, and a thickness of the second sub-photoresist layer is half the thickness of the photoresist layer.

In another aspect, a display panel includes: a top substrate, a down substrate, a photoresist layer between the top substrate and the down substrate; the display panel includes a transmission area and a reflective area having a reflective layer within the photoresist layer, the reflective layer divides the photoresist layer into a first sub-photoresist layer and a second sub-photoresist layer, the first sub-photoresist layer is arranged between the reflective layer and the down substrate, the second sub-photoresist layer is arranged between the reflective layer and the top substrate, the light beams within the transmission area pass through the photoresist layer, the light beams within the reflective area pass through the first sub-photoresist layer or the second sub-photoresist layer twice.

Wherein the display panel is a single-side display panel, the display panel further includes a light source arranged on the down substrate facing away the top substrate, the photoresist layer is arranged on the down substrate, and a reflective surface of the reflective layer faces toward the top substrate.

Wherein the first sub-photoresist layer and the second sub-photoresist layer are made by the same material, and a thickness of the second sub-photoresist layer is half the thickness of the photoresist layer.

Wherein the display panel is a double-side display panel, the display panel further includes a light source arranged on one side of the down substrate facing away the top substrate, and the photoresist layer is arranged on the top substrate, and a reflective surface of the reflective layer faces toward the down substrate.

Wherein the first sub-photoresist layer and the second sub-photoresist layer are made by the same material, and a thickness of the first sub-photoresist layer is half the thickness of the photoresist layer.

In another aspect, a manufacturing method of display panels includes: forming a first substrate having a transmission area and a reflective area; forming a first sub-photoresist layer on the first substrate; forming a reflective layer on the first sub-photoresist layer within the reflective area; forming a second sub-photoresist layer on the first sub-photoresist layer within the transmission area and forming the second sub-photoresist layer on the reflective layer, and the first sub-photoresist layer and the second sub-photoresist layer constitute the photoresist layer; arranging the second substrate in accordance with the first substrate, the photoresist layer is between the first substrate and the second substrate; and wherein the light beams within the transmission area pass through the photoresist layer, and the light beams within the reflective area pass through the second sub-photoresist layer twice.

The method further includes: arranging a light source at an outer side of the first substrate or a second substrate.

Wherein the step of forming a reflective layer on the first sub-photoresist layer within the reflective area further includes: forming the reflective layer on the first sub-photoresist layer within the reflective area, and a reflective surface of the reflective layer faces away the first sub-photoresist layer.

Wherein the step of forming the second sub-photoresist layer further includes: forming a second sub-photoresist layer on the first sub-photoresist layer within the transmission area and forming the second sub-photoresist layer on the reflective layer, the thickness of the photoresist layer formed by the first sub-photoresist layer and the second sub-photoresist layer is as twice as the thickness of the second sub-photoresist layer, and the first sub-photoresist layer and the second sub-photoresist layer are made by the same material.

Wherein the step of forming the second sub-photoresist layer further includes: forming a second sub-photoresist layer on the first sub-photoresist layer within the transmission area and forming the second sub-photoresist layer on the reflective layer, the thickness and the material of the first sub-photoresist layer and the second sub-photoresist layer are different, a saturation of the light beams within the transmission area, passing through the photoresist layer and the saturation of the light beams within the reflective area passing through the second sub-photoresist layer twice are the same.

In view of the above, the display panel includes a top substrate, a down substrate, and a photoresist layer between the top substrate and the down substrate. The display panel may be divided into a transmission area and a reflective area. The reflective area further includes a reflective layer within the photoresist layer. The reflective layer divides the photoresist layer into a first sub-photoresist layer and a second sub-photoresist layer. The first sub-photoresist layer is between the reflective layer and the down substrate, and the sub-photoresist layer is between the reflective layer and the top substrate. The light beams within the reflective area pass through the photoresist layer, and the light beams within the reflective area pass through the first sub-photoresist layer or the second sub-photoresist layer twice. By dividing the photoresist layer into two sub-photoresist layers via the reflective layer, the light beams within the reflective area pass through the photoresist layer, and the light beams within the reflective area pass through the sub-photoresist layer twice. The thickness of the sub-photoresist layer is smaller than the thickness of the photoresist layer. Thus, the saturation of the transmission area and that of the reflective area may be compatible.

### BRIEF DESCRIPTION OF THE DRAWINGS

FIG. 1 is a schematic view of the display panel in accordance with a first embodiment.

FIG. 2 is a schematic view of the display panel in accordance with a second embodiment.

FIG. 3 is a flowchart illustrating the manufacturing method of the display panel in accordance with one embodiment.

FIG. 4 is a schematic view of the display panel manufactured by the manufacturing method of FIG. 3.

FIG. 5 is a schematic view of another display panel manufactured by the manufacturing method of FIG. 3.

### DETAILED DESCRIPTION OF THE EMBODIMENTS

Embodiments of the invention will now be described more fully hereinafter with reference to the accompanying drawings, in which embodiments of the invention are shown.

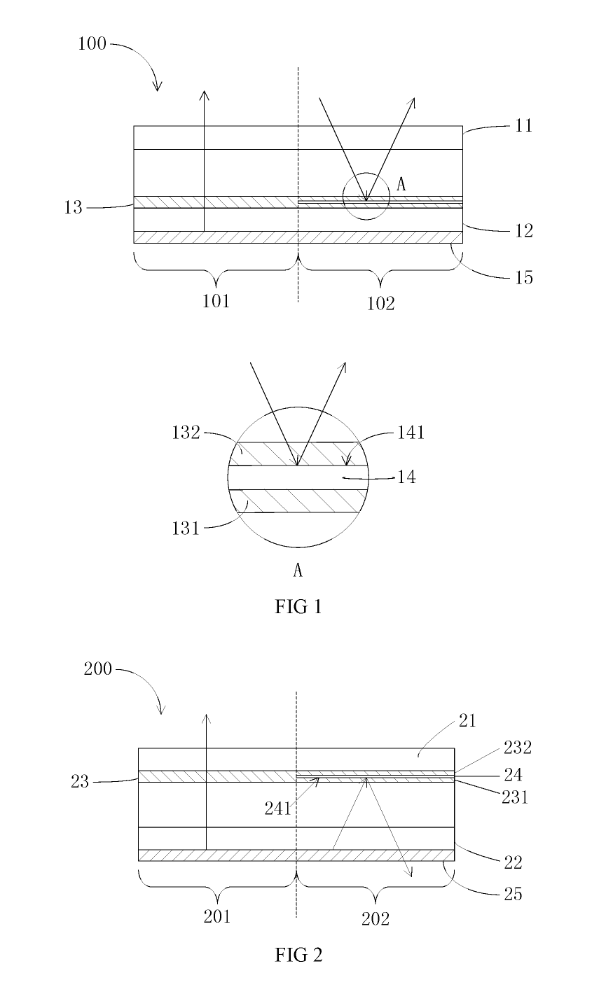

FIG. 1 is a schematic view of the display panel in accordance with a first embodiment. The display panel 100 includes a top substrate 11, a down substrate 12, a photoresist layer 13, and a reflective layer 14.

Generally, the substrate of the display panel may include a glass substrate, and thin film transistors (TFTs) arranged on the glass substrate. The photoresist layer is also called as the color filter layer. The reflective layer is generally adopted in the reflective display panel. The other portions of the display panel 100 may be conceived by persons in the ordinary skill and thus are omitted hereinafter.

The display panel 100 is of transflective type, and includes a transmission area 101 and a reflective area 102. The reflective layer 14 is arranged within the reflective area 102 and is within the photoresist layer 13. The reflective layer 14 divides the photoresist layer 13 into a first sub-photoresist layer 131 and a second sub-photoresist layer 132. The first sub-photoresist layer 131 is between the reflective layer 14 and the down substrate 12, and the second sub-photoresist layer 132 is between the reflective layer 14 and the top substrate 11. The reflective layer 14 is made by reflective materials, such as Al, Ag, and Cu. The manufacturing process of the metallic materials is simple, and the reflective effect is good. In an example, the aluminum foil may be adopted. The gross, the reflective effect, and the extensibility of the aluminum are good and suitable for manufacturing process of the reflective layer.

The light beams within the transmission area 101 pass through the sub-photoresist layer 13. When a reflective surface 141 of the reflective layer 14 faces toward the first sub-photoresist layer 131, the light beams within the reflective area 102 pass through the first sub-photoresist layer 131 twice. When the reflective surface 141 of the reflective layer 14 faces toward the second sub-photoresist layer 132, the light beams within the reflective area 102 pass through the second sub-photoresist layer 132 twice.

Under the two conditions, the light beams within the reflective area 102 pass through the sub-photoresist layer twice. The thickness of the sub-photoresist layer is smaller than the thickness of the photoresist layer 13. Thus, the saturation of the reflective area 102 and that of the transmission area 101 may be compatible.

In the embodiment, the display panel 100 is a single-side display panel. The reflective layer 15 is arranged on one side of the down substrate 12 facing away the top substrate 11, the photoresist layer 13 is arranged on the down substrate 12, the reflective surface 141 of the reflective layer 14 faces toward the top substrate 11. The light source 15 is configured as a rear light source for the transmission area 101. The light beams from the reflective layer 15 pass through the photoresist layer 13 and are then observed by human eyes. The light beams from the reflective layer 15 cannot pass through the reflective area 102, that is, the reflective area 102 may only emit lights by the ambient lights. Specifically, the ambient lights pass through the second sub-photoresist layer 132 and are reflected by the reflective layer 14. The reflected light beams pass through the second sub-photoresist layer 132 again so as to be observed by human eyes.

As the material and the thickness of the photoresist layer may affect the saturation of the light beams. In order to obtain compatible saturation for the reflective area 102 and the transmission area 101, the material of the first sub-photoresist layer 131 and the second sub-photoresist layer 132 are the same. In addition, the thickness of the second sub-photoresist layer 132 (H₂) is only half of the thickness of the photoresist layer 13 (H₀).

When the thickness of the reflective layer 14 (H) is smaller than the thickness of the photoresist layer 13 (H₀), the thickness of the reflective layer 14 (H) may be omitted. That is, the thickness of the photoresist layer 13 (H₀) equals to a sum of the thickness of the first sub-photoresist layer 131 (H₁) and the thickness of the second sub-photoresist layer 132 (H₂), i.e., H₀=H₁+H₂ The thickness of the first sub-photoresist layer 131 (H₁) is configured to be the same with the thickness of the second sub-photoresist layer 132 (H₂), i.e., H₁=H₂. Thus, the thickness of the second sub-photoresist layer 132 (H₂) is half of the thickness of the photoresist layer 13 (H₀).

When the thickness of the reflective layer 14 (H) is larger and cannot be omitted, the thickness of the photoresist layer 13 (H₀)=H₁+H₂+H. In the end, the thickness of the second sub-photoresist layer 132 (H₂) equals to half of the thickness of the photoresist layer 13 (H₀), i.e., H₀=2×H₂. The relationship between H₁ and H₂: 2×H₂=H₁+H₂+H. That is, H₂=H₁+H. According to the relationship, the first sub-photoresist layer 131 and the second sub-photoresist layer 132 are formed such that the thickness of the second sub-photoresist layer 132 (H₂) is half of the thickness of the photoresist layer 13 (H₀).

It can be understood that the first sub-photoresist layer 131 and the second sub-photoresist layer 132 may be made by different materials. In addition, the thickness of the first sub-photoresist layer 131 and the second sub-photoresist layer 132 may be respectively configured such that the saturation of the light beams within the transmission area 101, passing through the photoresist layer 13, and the saturation of the light beams within the reflective area 102, passing through the second sub-photoresist layer 132 twice, may be the same.

Referring to FIG. 1, it is to be noted that the cell thickness of the display panel 100 with respect to the transmission area 101 and the reflective area 102 are the same. In real applications, the cell thickness may be different. In FIG. 1, the same cell thickness regarding the transmission area 101 and the reflective area 102 is only one example, that is, the cell thickness of the transmission area 101 and the reflective area 102 are not limited thereto. For the display panels wherein different thicknesses being configured with respect to the transmission area and the reflective area, the above configuration of the photoresist layer may also be employed.

FIG. 2 is a schematic view of the display panel in accordance with a second embodiment. The display panel 200 includes a top substrate 21, a down substrate 22, a photoresist layer 23 between the top substrate 21 and the down substrate 22, and a reflective layer 24.

The display panel 200 includes the transmission area 201 and the reflective area 202. The reflective layer is arranged within the reflective area 202 and is within the photoresist layer 23. The reflective layer divides the photoresist layer into a first sub-photoresist layer 231 and a second sub-photoresist layer 232. The first sub-photoresist layer 231 is between the reflective layer 24 and the down substrate 22, and the second sub-photoresist layer 232 is between the reflective layer 24 and the top substrate 21.

The structure of the display panel 200 is substantially the same with that of the display panel 100. The difference between the display panel 100 and the display panel 200 resides in that the display panel 200 is a double-sided display panel. The light source 25 is arranged on one side of the down substrate 22 facing away the top substrate 21. The photoresist layer 23 is arranged on the top substrate 21, the reflective surface 241 of the reflective layer 24 faces toward the down substrate 22. The light beams from the reflective area 202 pass through the sub-photoresist layer 231 twice.

With respect to the display panel 200, the light source 25 is configured as the rear light source for the transmission area 201. The light beams pass through the down substrate 22 and are observed by human eyes. With respect to the reflective area 202, the light source 25 is configured as the front light source. The light beams from the light source 25 enter via the down substrate 22, arrives the sub-photoresist layer 231, and are reflected by the reflective layer 24. The reflected light beams pass through the sub-photoresist layer 231 and then are observed by human eyes.

Similarly, the sub-photoresist layer 231 may be made by the same material with the second sub-photoresist layer 232, the thickness of the first sub-photoresist layer 231 (H₁) is half of the thickness of the photoresist layer 23 (H₀).

It can be understood that the first sub-photoresist layer 231 and the second sub-photoresist layer 232 may be made by different materials. In addition, the thickness of the first sub-photoresist layer 231 and the second sub-photoresist layer 232 may be respectively configured such that the saturation of the light beams within the transmission area 101, passing through the photoresist layer 23, and the saturation of the light beams within the reflective area 102, passing through the second sub-photoresist layer 232 twice, may be the same.

In view of the above, the display panel includes a top substrate, a down substrate, and a photoresist layer between the top substrate and the down substrate. The display panel may be divided into a transmission area and a reflective area. The reflective area further includes a reflective layer within the photoresist layer. The reflective layer divides the photoresist layer into a first sub-photoresist layer and a second sub-photoresist layer. The first sub-photoresist layer is between the reflective layer and the down substrate, and the sub-photoresist layer is between the reflective layer and the top substrate. The light beams within the reflective area pass through the photoresist layer, and the light beams within the reflective area pass through the first sub-photoresist layer or the second sub-photoresist layer twice. By dividing the photoresist layer into two sub-photoresist layers via the reflective layer, the light beams within the reflective area pass through the photoresist layer, and the light beams within the reflective area pass through the sub-photoresist layer twice. The thickness of the sub-photoresist layer is smaller than the thickness of the photoresist layer. Thus, the saturation of the transmission area and that of the reflective area may be compatible.

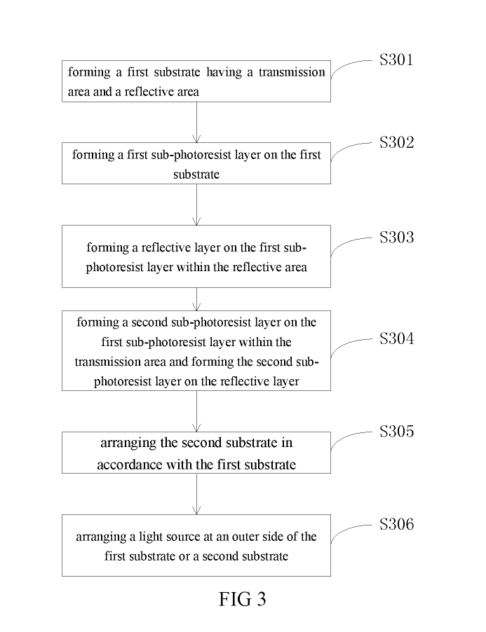

FIG. 3 is a flowchart illustrating the manufacturing method of the display panel in accordance with one embodiment.

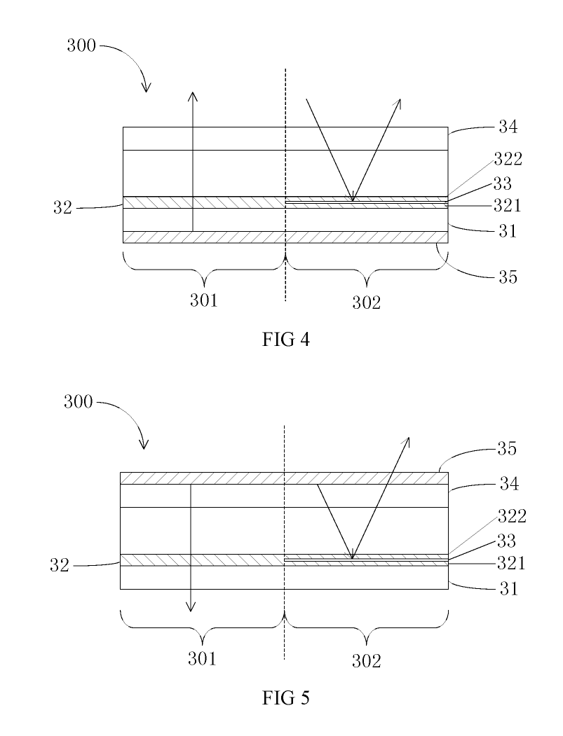

FIG. 4 is a schematic view of the display panel manufactured by the manufacturing method of FIG. 3. FIG. 5 is a schematic view of another display panel manufactured by the manufacturing method of FIG. 3. The difference between FIGS. 4 and 5 only resides in the configuration of the light source, and thus the reference numerals regarding the display panel are the same.

The manufacturing method of FIG. 3 includes the following steps.

In block S301, forming a first substrate.

The first substrate 31 includes a transmission area 301 and a reflective area 302. That is, the manufactured display panel 300 includes the transmission area 301 and the reflective area 302.

In block S302, forming a first sub-photoresist layer on the first substrate.

The first sub-photoresist layer 321 is formed on the first substrate 31.

In block S303, forming a reflective layer on the first sub-photoresist layer within the reflective area.

The reflective layer 33 is formed on the first sub-photoresist layer 321 of the reflective area 302.

In block S304, forming a second sub-photoresist layer on the first sub-photoresist layer within the transmission area and the reflective layer, and the first sub-photoresist layer and the second sub-photoresist layer form the photoresist layer.

A second sub-photoresist layer 322 is formed on the first sub-photoresist layer 321 within the transmission area 301 and the on the reflective layer 33. The first sub-photoresist layer 321 and the second sub-photoresist layer 322 form the photoresist layer 32.

If the first sub-photoresist layer 321 and the second sub-photoresist layer 322 are made by the same material, the thickness of the photoresist layer 32 is as twice as the thickness of the second sub-photoresist layer 322.

If the first sub-photoresist layer 321 and the second sub-photoresist layer 322 are made by different materials, different thickness may be configured in accordance with different materials. As such, the saturation of the light beams within the transmission area 301 passing through the photoresist layer 32 is the same with that of the light beams within the reflective area 302 passing through the second sub-photoresist layer 322 twice.

In block S305, arranging the second substrate in accordance with the first substrate. The photoresist layer is between the first substrate and the second substrate.

The second substrate 34 is arranged in accordance with the first substrate 31. That is, the first substrate 31 and the second substrate 34 form a cell, and the liquid crystals are filled between the two substrates. The photoresist layer 32 is between the first substrate 31 and the second substrate 34.

In block S306, the light source is arranged at an outer side of the first substrate or the second substrate.

When the light source 35 is arranged at an outer side of the first substrate 31, as shown in FIG. 4, the display panel 300 is a single-side display. The light beams from the transmission area 301 enter the first substrate 31, pass through the photoresist layer 32, and emit out via the second substrate 34. The light beams from the reflective area 302 enter from the second substrate 34. As being reflected by the reflective layer 33, the light beams pass through the second sub-photoresist layer 322 twice, and then emit out via the second substrate 34. Due to the configuration of the second sub-photoresist layer 322 in block S304, the saturation of the transmission area 301 and the reflective area 302 are compatible. The display panel 300 in FIG. 4 corresponds to the above display panel 100.

When the light source 35 is arranged at an outer side of the second substrate 34, as shown in FIG. 5, the display panel 300 is a double-side display. The light beams from the transmission area 301 enter the second substrate 34, pass through the photoresist layer 32, and emit out via the first substrate 31. The light beams from the reflective area 302 enter from the second substrate 34. As being reflected by the reflective layer 33, the light beams pass through the second sub-photoresist layer 322 twice, and then emit out via the light source 35 such that the saturation of the transmission area 301 and the reflective area 302 are compatible. The display panel 300 in FIG. 5 corresponds to the above display panel 200.

In view of the above, the manufacturing method forms the first sub-photoresist layer, the reflective layer, and the second sub-photoresist layer in turn. The first sub-photoresist layer and the second sub-photoresist layer form the photoresist layer such that the reflective layer is within the photoresist layer. The light beams within the transmission area pass through the photoresist layer, and the light beams within the reflective area pass through the second sub-photoresist layer twice. The thickness of the second sub-photoresist layer is smaller than that of the photoresist layer. Thus, the saturation of the transmission area and that of the reflective area may be compatible.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display panel, comprising:
a top substrate, a down substrate, a photoresist layer between the top substrate and the down substrate;
the display panel comprises a transmission area and a reflective area having a reflective layer within the photoresist layer, the reflective layer divides the photoresist layer into a first sub-photoresist layer and a second sub-photoresist layer, the first sub-photoresist layer is arranged between the reflective layer and the down substrate, the second sub-photoresist layer is arranged between the reflective layer and the top substrate, the light beams within the transmission area pass through the photoresist layer, the light beams within the reflective area pass through the first sub-photoresist layer or the second sub-photoresist layer twice;
the display panel is a single-side display panel, the display panel further comprises a light source arranged on the down substrate facing away the top substrate, the photoresist layer is arranged on the down substrate, and a reflective surface of the reflective layer faces toward the top substrate; and
the reflective layer is a metallic reflective layer.

2. The display panel as claimed in claim 1, wherein the first sub-photoresist layer and the second sub-photoresist layer are made by the same material, and a thickness of the second sub-photoresist layer is half the thickness of the photoresist layer.

3. A display panel, comprising:
a top substrate, a down substrate, a photoresist layer between the top substrate and the down substrate;
the display panel comprises a transmission area and a reflective area having a reflective layer within the photoresist layer, the reflective layer divides the photoresist layer into a first sub-photoresist layer and a second sub-photoresist layer, the first sub-photoresist layer is arranged between the reflective layer and the down substrate, the second sub-photoresist layer is arranged between the reflective layer and the top substrate, the light beams within the transmission area pass through the photoresist layer, the light beams within the reflective area pass through the first sub-photoresist layer or the second sub-photoresist layer twice.

4. The display panel as claimed in claim 3, wherein the display panel is a single-side display panel, the display panel further comprises a light source arranged on the down substrate facing away the top substrate, the photoresist layer is arranged on the down substrate, and a reflective surface of the reflective layer faces toward the top substrate.

5. The display panel as claimed in claim 4, wherein the first sub-photoresist layer and the second sub-photoresist layer are made by the same material, and a thickness of the second sub-photoresist layer is half the thickness of the photoresist layer.

6. The display panel as claimed in claim 3, wherein the display panel is a double-side display panel, the display panel further comprises a light source arranged on one side of the down substrate facing away the top substrate, and the photoresist layer is arranged on the top substrate, and a reflective surface of the reflective layer faces toward the down substrate.

7. The display panel as claimed in claim 6, wherein the first sub-photoresist layer and the second sub-photoresist layer are made by the same material, and a thickness of the first sub-photoresist layer is half the thickness of the photoresist layer.

8. A manufacturing method of display panels, comprising:
forming a first substrate having a transmission area and a reflective area;
forming a first sub-photoresist layer on the first substrate;
forming a reflective layer on the first sub-photoresist layer within the reflective area;
forming a second sub-photoresist layer on the first sub-photoresist layer within the transmission area and forming the second sub-photoresist layer on the reflective layer, and the first sub-photoresist layer and the second sub-photoresist layer constitute the photoresist layer;
arranging the second substrate in accordance with the first substrate, the photoresist layer is between the first substrate and the second substrate; and
wherein the light beams within the transmission area pass through the photoresist layer, and the light beams within the reflective area pass through the second sub-photoresist layer twice.

9. The manufacturing method as claimed in claim 8, the method further comprises:
arranging a light source at an outer side of the first substrate or a second substrate.

10. The manufacturing method as claimed in claim 8, wherein the step of forming a reflective layer on the first sub-photoresist layer within the reflective area further comprises:
forming the reflective layer on the first sub-photoresist layer within the reflective area, and a reflective surface of the reflective layer faces away the first sub-photoresist layer.

11. The manufacturing method as claimed in claim 8, wherein the step of forming the second sub-photoresist layer further comprises:
forming a second sub-photoresist layer on the first sub-photoresist layer within the transmission area and forming the second sub-photoresist layer on the reflective layer, the thickness of the photoresist layer formed by the first sub-photoresist layer and the second sub-photoresist layer is as twice as the thickness of the second sub-photoresist layer, and the first sub-photoresist layer and the second sub-photoresist layer are made by the same material.

12. The manufacturing method as claimed in claim 8, wherein the step of forming the second sub-photoresist layer further comprises:
forming a second sub-photoresist layer on the first sub-photoresist layer within the transmission area and forming the second sub-photoresist layer on the reflective layer, the thickness and the material of the first sub-photoresist layer and the second sub-photoresist layer are different, a saturation of the light beams within the transmission area, passing through the photoresist layer and the saturation of the light beams within the reflective area passing through the second sub-photoresist layer twice are the same.
